(19) United States
(12) Patent Application Publication
(10) Pub. No.: US 2008/0102332 A1
(43) Pub. Date: May 1, 2008

(54) DEVICE FOR MEASURING ELECTRICAL OUTPUT AND FUEL CELL STACK INCLUDING THE SAME

(75) Inventors: Jae-Woong Choi, Yongin-si (KR); Sang-Min Jeong, Yongin-si (KR); Min-Jung Oh, Yongin-si (KR); Sung-Chul Lee, Yongin-si (KR); Woong-Ho Cho, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD, Suwon-si (KR)

(21) Appl. No.: 11/877,506

(22) Filed: Oct. 23, 2007

(30) Foreign Application Priority Data
Nov. 1, 2006 (KR) 10-2006-0107223

(51) Int. Cl. H01M 8/04

(52) U.S. Cl. 429/23

(57) ABSTRACT

A fuel cell stack includes a body that includes electrical generators and a device that is electrically connected to the electrical generators to measure an electrical output from the electrical generators. The device includes a base substrate that is fixed to the body and terminal members that are formed on the base substrate and electrically connected to the electrical generators.

### CROSS-REFERENCE TO RELATED APPLICATION

This application claims priority to and the benefit of Korean Patent Application No. 10-2006-0107223, filed on Nov. 1, 2006 in the Korean Intellectual Property Office, the entirety of which is incorporated herein by reference.

### BACKGROUND OF THE INVENTION

1. Technical Field

This disclosure relates to a fuel cell stack, and more particularly, to a device for measuring an electrical output from unit cells of an electrical generator.

2. Description of the Related Art

A fuel cell is an electrical generating system that directly converts chemical energy, in a reaction between a fuel and an oxidant, to electrical energy. Fuel cells may be classified into various types according to the components of systems and kinds of fuels.

Some fuel cells include a stack constructed of sequentially disposed unit cells. Accordingly, this type of fuel cell (hereinafter, referred to as “fuel cell stack”) generates electrical energy by supplying fuel and oxidant to each of the unit cells.

In order to check a performance of the fuel cell stack, a device for measuring a voltage that is output from each unit cell has been used. An existing device for measuring a cell voltage includes a needle-type connection terminal. When an anomaly of the system is found, the connection terminal is electrically connected to each unit cell of the fuel cell stack to measure the voltage output from the unit cells.

Since the device for measuring the electrical output is separate from the system, when the anomaly in the system is found, a user determines whether the stack is defective by measuring the output voltage of each unit cell of the fuel cell stack using the device for measuring the electrical output.

Accordingly, since the voltage output from each unit cell is not measured in real time while the stack is being driven, it is impossible to rapidly determine whether the anomaly in the system occurs in the stack.

### SUMMARY OF THE INVENTION

Some embodiments provides a device for measuring in real time an electrical output from each unit cell of a fuel cell stack, and a fuel cell stack into which the device is integrated.

An aspect provides a fuel cell stack including: a body that includes an electrical generator; and a device that is electrically connected to the electrical generator to measure an electrical output from the electrical generator. The device includes: a base substrate that is fixed to the body; and a terminal member that is formed on the base substrate and electrically connected to the electrical generator.

In the above aspect, a space is formed between the contact portion and the base substrate, and the terminal member may include a contact portion that is elastically deformed at a contact point with the electrical generator.

In addition, the terminal member may be formed as a micro-elastic body. In this case, the terminal member may include: a first portion that is formed as an elastic body; and second portions that are connected to the first portion and fixed to the base substrate to support the first portion.

In addition, the first portion may be formed as a plate spring that protrudes from the second portions. The cross-section of the first portion may have a trapezoidal shape. In this case, the second portions may be disposed at both ends of the first portion, and one of the second portions may be formed as a lead that is electrically connected to a connector.

In addition, the terminal member may be formed by plating a nickel based metal on a conductive metal thin film.

In addition, the device further may include a contact member that is formed on the terminal member and electrically connected to the electrical generator.

In addition, the contact member may be formed separately from the terminal member and adhered to the terminal member. The contact member has a ball shape.

In addition, the contact member may be formed as a protrusion of the terminal member.

In addition, in the device, the terminal member may be electrically connected to a circuit pattern formed on the base substrate.

In addition, the terminal member may be electrically connected to a detector through the connector formed on the base substrate. In this case, the detector may be a voltmeter or an ammeter.

The fuel cell stack may further include engaging members for engaging the base substrate with the body.

In addition, in the fuel cell stack, a plurality of electrical generators and a plurality of terminal members may be provided, and the terminal members are connected to corresponding electrical generators.

In addition, in the fuel cell stack, the body may include pressing plates that are disposed at outermost sides, and the base substrate may be fixed to the pressing plates by using the engaging members.

In addition, in the fuel cell stack, the electrical generator may include a conductive separator, and the body may be constructed as a small sized cell in which the conductive separator has a thickness of about 1 to 1.2 mm.

Another aspect provides a fuel cell stack including: a body that includes a plurality of electrical generators; and a device that is fixed to the body to measure an electrical output from each electrical generator. In this case, the device may be disposed to face one side of the body.

Another aspect provides a device that is electrically connected to a fuel cell body to measure an electrical output from the electrical generators, the device including: a base substrate that is fixed to the body; and a terminal member that is formed on the base substrate and electrically connected to a corresponding electrical generator, wherein the terminal member is formed as a micro-elastic body.

In the above aspect, the terminal member may form a space between the contact portion and the base substrate, and may include a contact portion that is elastically deformed at a contact point with the electrical generator.

In addition, in the device, the terminal member may include a first portion that is formed as an elastic body and second portions that are connected to the first portion and fixed to the base substrate to support the first portion, and the first portion may be formed as a plate spring that protrudes from the second portion.

In addition, the device may further include a contact member that is formed on the terminal member and electrically connected to the electrical generator. In this case, the contact member, which has a ball shape, may be formed separately from the terminal member and adhered to the terminal member. Alternatively, the contact member may be formed as a protrusion of the terminal member.

In addition, the terminal member may be formed by plating a nickel-based metal on a conductive metal thin film.

Other embodiments provide a fuel cell stack comprising: a body comprising an electrical generator; and a device operable to measure an electrical output of the electrical generator electrically coupled to the electrical generator, wherein the device comprises: a base substrate secured to the body; and a terminal member disposed on the base substrate and electrically coupled to the electrical generator.

In some embodiments, the terminal member comprises a contact portion that is elastically deformed at a contact point with the electrical generator. Some embodiments comprise a space between the contact portion and the base substrate.

In some embodiments, the terminal member comprises a micro-elastic body. In some embodiments, the terminal member comprises: a first portion comprising an elastic body; and second portions coupled to the first portion and fixed to the base substrate, thereby supporting the first portion. In some embodiments, the first portion comprises a plate spring that protrudes from the second portions. In some embodiments, a cross-section of the first portion has a trapezoidal shape. In some embodiments, a second portion is disposed at each end of the first portion, and one of the second portions comprises a lead electrically coupled to a connector.

In some embodiments, the terminal member comprises a nickel-based metal plated on a conductive metal thin film.

Some embodiments further comprise a contact member on the terminal member, wherein the contact member is electrically coupled to the electrical generator. In some embodiments, the contact member is adhered to the terminal member. In some embodiments, the contact member has a ball shape. In some embodiments, the contact member comprises a projection on the terminal member.

In some embodiments, the terminal member is electrically coupled to a circuit pattern disposed on the base substrate. In some embodiments, the terminal member is electrically coupled to a detector through a connector disposed on the base substrate. In some embodiments, the detector comprises at least one of a voltmeter and an ammeter.

Some embodiments further comprise engaging members securing the base substrate to the body.

In some embodiments, the body comprises a plurality of electrical generators and the device comprises a plurality of terminal members, and each terminal member is coupled to a corresponding electrical generator.

In some embodiments, the body comprises pressing plates disposed at outermost sides, and engaging members secure the base substrate to the pressing plates.

In some embodiments, the electrical generator comprises a conductive separator, and the body comprises a small sized cell comprising a conductive separator with a thickness of from about 1 mm to about 1.2 mm.

Other embodiments provide a fuel cell stack comprising: a body comprising a plurality of electrical generators; and a device secured to the body operable to measure an electrical output from each electrical generator.

In some embodiments, the device is disposed on a side face of the body.

Other embodiments provide a device for measuring an electrical output from a plurality of electrical generators of a fuel cell stack, the device comprising: a base substrate dimensioned and configured for securing to a body of a fuel cell stack; and a plurality of terminal members disposed on the base substrate, wherein each terminal member is operable for electrical coupling to a corresponding electrical generator of a fuel cell stack, wherein each terminal member comprises a micro-elastic body.

In some embodiments, a terminal member comprises a contact portion dimensioned and configured to be elastically deformed at a contact point with the electrical generator to form a space between the contact portion and the base substrate. In some embodiments, a terminal member comprises a first portion comprising an elastic body and second portions connected to the first portion and fixed to the base substrate, thereby supporting the first portion, and the first portion comprises a plate spring projecting from the second portions.

Some embodiments further comprise a contact member disposed on the terminal member, dimensioned and configured for electrical coupling to the electrical generator.

In some embodiments, the contact member is ball shaped and is adhered to the terminal member. In some embodiments, the contact member comprises a projection on the terminal member.

In some embodiments, the terminal member comprises a nickel-based metal plated on a conductive metal thin film.

### BRIEF DESCRIPTION OF THE DRAWINGS

The above and other features and advantages will become more apparent by describing in detail exemplary embodiments thereof with reference to the attached drawings, in which:

FIG. 1 a perspective view illustrating a fuel cell stack according to a first embodiment;

FIG. 2 is a perspective view illustrating a device for measuring an electrical output of the fuel cell stack shown in FIG. 1;

FIG. 3 is a cross-sectional view taken along section line III-III of FIG. 2;

FIG. 4 is a schematic diagram illustrating an operation of the device for measuring an electrical output shown in FIG. 3; and

FIG. 5 is a cross-sectional view schematically illustrating a fuel cell stack according to a second embodiment.

### DETAILED DESCRIPTION OF CERTAIN EMBODIMENTS

Certain embodiments will now be described more fully hereinafter with reference to the accompanying drawings. As those skilled in the art would realize, the described embodiments may be modified in various different ways, all without departing from the spirit or scope of the disclosure.

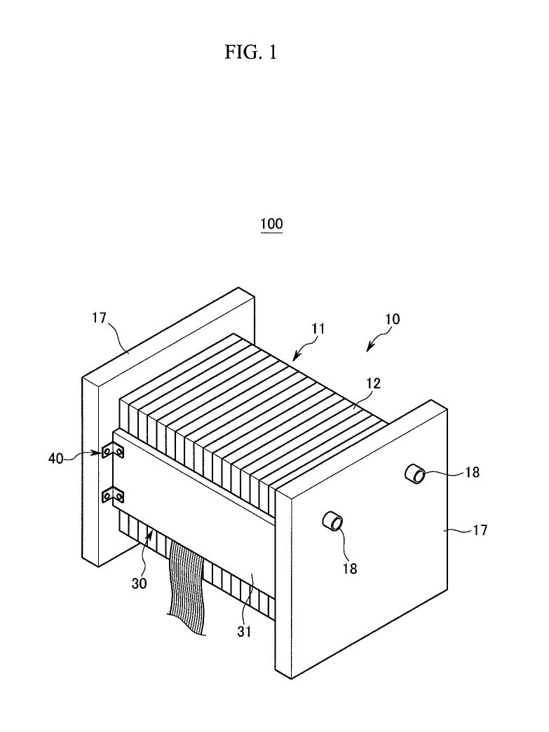

FIG. 1 a perspective view illustrating a fuel cell stack 100 according to a first embodiment. Referring to FIG. 1, a fuel cell stack 100 according to the first embodiment is constructed as an electrical generating system for generating electrical energy by a chemical reaction between a fuel and an oxidant.

The fuel may include an alcohol-based liquid fuel such as methanol and/or ethanol. The fuel may include a liquid fuel or a reforming gas obtained by reforming a gaseous fuel such as methane, ethane, propane, and/or butane. The oxidant may be oxygen gas contained in a separate tank or air.

The fuel cell stack 100 includes a fuel cell body 10 (hereinafter, for convenience, referred to as “body”), including a plurality of electrical generators 11.

The body 10 includes the plurality of electrical generators 11 in unit cells. The body 10 is constructed as a stack by sequentially assembling the plurality of electrical generators 11. The body 10 includes pressing plates 17 for closely packing the electrical generators 11 disposed at outermost sides thereof. A plurality of ports 18 formed in the pressing plates 17 permit discharging fuel and oxidant that remain in the electrical generators 11 after a reaction therein, as well as a product thereof.

Each electrical generator 11 includes a separator 12 (also referred to as a “bipolar plate”) and a general membrane-electrode assembly (MEA) (not shown) adhered to both sides of the separator 12. The separator 12 comprises a conductor, for example, a metal and/or graphite. Channels through which fuel and oxidant flow are formed in both sides of the separator 12. The separators 12 are from about 1 mm to about 1.2 mm thick and can constitute the body 10 of a small-sized fuel cell.

The fuel cell stack 100 includes a device 30 for measuring an electrical output according to some embodiments. The device 30 is used to measure an electrical output from the electrical generators 11 of the body 10.

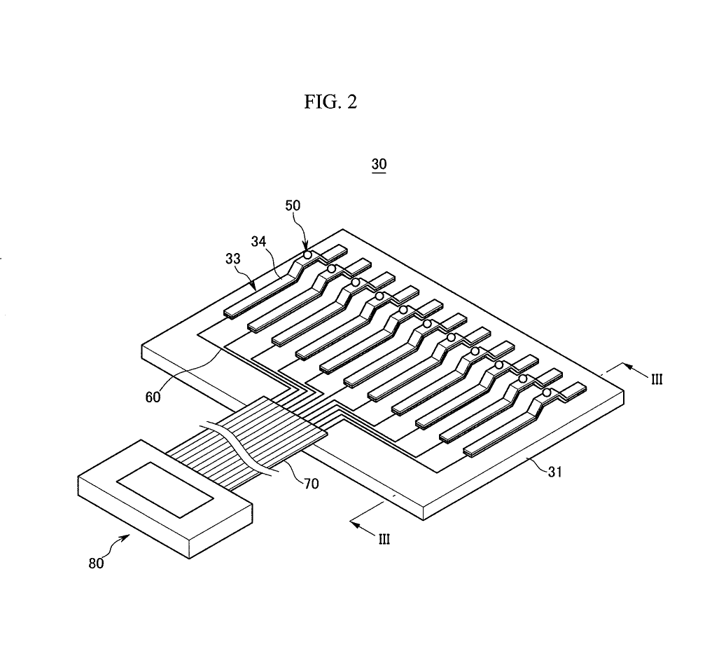

According to the embodiment, the device 30 is electrically coupled to each of the electrical generators 11, separately. The device 30 is configured so that a voltage or a current output from each electrical generator 11 is supplied to a detector 80 (FIG. 2), as described below. The device 30 is disposed on one side of the body 10 and fixed thereto.

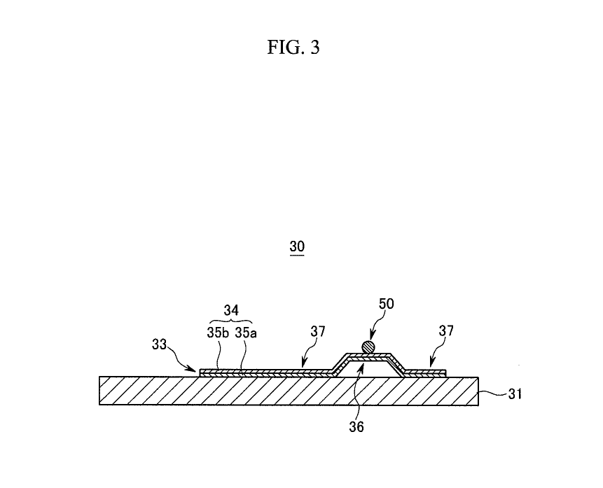

FIG. 2 is a perspective view illustrating the device 30 for measuring an electrical output shown in FIG. 1, and FIG. 3 is a cross-sectional view taken along section line III-III of FIG. 2.

Referring to FIGS. 2 and 3, the device 30 according to the embodiment includes a base substrate 31 fixed to the body 10 and a plurality of terminal members 33 formed on the base substrate 31, which are conductive and electrically connected to each electrical generator 11 (FIG. 1).

The base substrate 31, comprises an insulating material such as a plastic or a glass, supports the terminal members 33. As shown in FIG. 1, the base substrate 31 is mounted on the body 10 using engaging members 40 using any suitable means, such as bolts and L-shaped brackets. The base substrate 31 is disposed on a face of the body 10 between the pressing plates 17, and is fixed to the pressing plates 17 by the engaging members 40.

According to the present embodiment, each terminal member 33 is separately electrically coupled to a respective electrical generator 11. The terminal members 33 supply a voltage and/or current from each electrical generator 11 to the detector 80. The terminal members 33 are electrically coupled to corresponding separators 12 (FIG. 1) of the electrical generators 11.

In some embodiments, the terminal members 33 are elastic. The terminal members 33 are formed on an upper surface of the base substrate 31. The terminal members 33 are spaced apart from one another by a specific interval along the direction in which the electrical generators 11 are arranged.

In the present embodiment, as shown in FIG. 3, the terminal members 33 comprise micro-elastic bodies 34 that are biased by the separators 12 and elastically deformed when the base substrate 31 is mounted on the body 10.

Each micro-elastic body 34 is supported by the upper surface of the base substrate 31. In the illustrated embodiment, the micro-elastic body 34 comprises a nickel-based electric plating layer 35b disposed on a conductive metal thin film 35a. The micro-elastic body 34, which is elastic, comprises an elastic member that forms a space between the base substrate 31 and the micro-elastic body 34.

The micro-elastic body 34 includes a first portion 36 and second portions 37 that are formed with the first portion 36 as one body. The first portion 36, which can be elastically deformed by the separator 12, is formed as a contact portion. The first portion 36 is formed as a plate spring that projects from the second portions 37.

In the illustrated embodiment, the cross-section of the first portion 36 has a generally trapezoidal shape, thereby forming the space between the first portion 36 and the base substrate 31. The second portions 37 extend from each end of the first portion 36 as one body and are fixed to the surface of the base substrate 31, thereby supporting the first portion 36.

Returning to FIG. 2, one of the second portions 37 is longer than the other and is formed as a lead that is electrically coupled to the detector 80 through a connector 70, that will be described below. The micro-elastic bodies 34 may be formed on the base substrate 31, for example, by micro-machining using lithography and electric plating.

The device 30 according to the present embodiment includes contact members 50 that are formed on the terminal members 33. The contact members 50 electrically couple the terminal members 33 to the corresponding separators 12.

The contact members 50 are formed as probe tips. Each contact member 50 may have a ball shape that is adhered to the first portion 36 as a separate member. The contact member 50 may include a solder ball or gold ball, for example, of the type used for a semiconductor packaging process.

As shown in FIG. 2, the device 30 for measuring an electrical output according to the embodiment further includes a circuit pattern 60 that electrically couples each terminal member 33 to the connector 70, which is in turn, coupled to the detector 80.

The circuit pattern 60 is formed, for example, as a copper clad layer that is printed on the surface of the base substrate 31 and electrically coupled to the second portions 37 of the micro-elastic bodies 34.

The connector 70 is formed as a flexible printed circuit (FPC) that electrically couples the circuit pattern 60 to the detector 80. A first end of the connector 70 is electrically coupled to the circuit pattern through a general anisotropic conductive film (ACF). {introduce “first” and “second” ends of connector}

The detector 80 is coupled to a terminal formed on a second end of the connector 70 through a female-male engagement. As described above, the detector 80 receives an electrical output from each electrical generator 11 of the body 10 through the contact members 50, the terminal members 33, the circuit pattern 60, and the connector 70. The detector 80 may include a general voltmeter and/or an ammeter that converts the electrical energy into a voltage and/or a current value and displays the value(s).

In the aforementioned fuel cell stack 100 according to the present embodiment, the device 30 for measuring an electrical output is mounted on one side of the body 10 using the engaging members 40. Each contact member 50 separately contacts a corresponding separator 12 of the electrical generators 11.

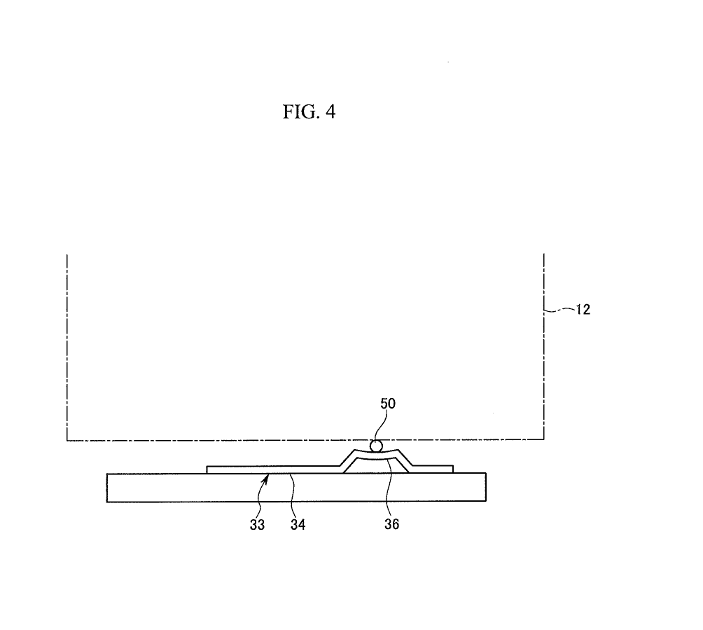

With the terminal members 33 formed as micro-elastic bodies 34 as described above, the first portions 36 of the terminal members 33 are elastically deformed by the contact between each separator 12 and a corresponding contact member 50, as shown in FIG. 4.

Since the terminal members 33 form a space between the first portions 36 and the base substrate 31, the terminal members 33 can be elastically deformed. As the first portions 36 are elastically deformed, there may be no space between the first portions 36 and the base substrate 31.

Accordingly, even if the surfaces of the separators 12 corresponding to the contact members 50 have varying or stepped heights, the elastic restoring force of the first portions 36 of the terminal members 33 allow the contact members 50 to contact corresponding separators 12. That is, the terminal members 33 have different elastic deformations corresponding to the stepped heights of the separators 12 thereby providing good contact between the contact members 50 and the corresponding separators 12. {add “varying” for clarification}

The contact members 50 conduct the electrical energy, which is generated by the electrical generators 11 while the stack 100 is driven, to the detector 80 through the terminal members 33, the circuit pattern 60, and the connector 70. Then, the detector 80 converts the electrical energy into a voltage and/or a current value and displays the value(s).

Since the device 30 is mounted on the body 10 in the embodiment, the electrical output from each electrical generator 11 while the stack 100 is driven, can be monitored in real time without increasing the size of the entire system.

Namely, it is possible to rapidly determine whether an anomaly in the system occurs in the stack. Since the terminal members 33 are formed as micro-elastic bodies 34, even if the surfaces of the separators 12 have stepped heights, the terminal members 33 allow the contact members 50 to electrically contact the corresponding separators 12 of the electrical generators 11.

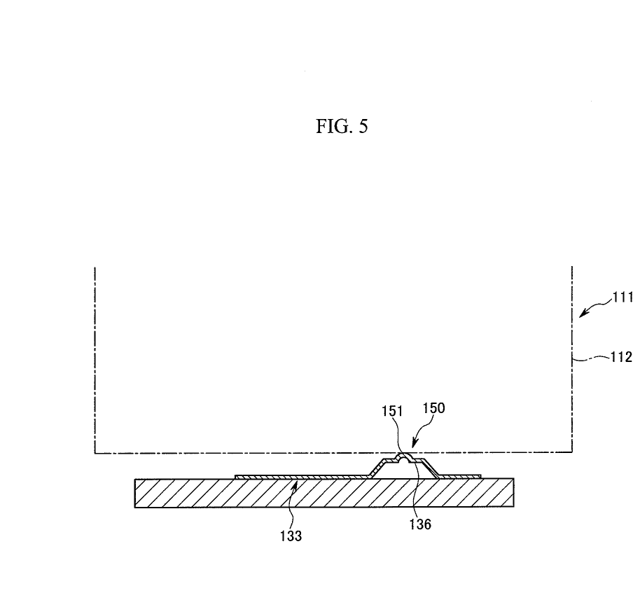

FIG. 5 is a cross-sectional view schematically illustrating a fuel cell stack according to a second embodiment. Referring to FIG. 5, a fuel cell stack according to the second embodiment has a similar structure to the previous embodiment except that contact members 150 are formed as projections 151 from the terminal members 133.

Since the projections 151 are integrated into the first portions 136 of the terminal members 133, the projections 151 extend from the elastic first portions 136 toward corresponding separators 112 of the electrical generators 111 thereby contacting the separators 112.

Since other components and operations of the aforementioned fuel cell stack according to the second embodiment are similar as those of the aforementioned fuel cell stack according to the first embodiment, a detailed description thereof is omitted.

As described above, according to certain embodiments a device for measuring an electrical output is integrated into the fuel cell stack permitting measurement of the electrical output from electrical generators in real time without increasing the size of the entire system. Accordingly, some embodiments permit the rapid determination of whether an anomaly in the system occurs in the stack.

In addition, according to some embodiments, since the terminal members of the device for measuring an electrical output are formed as micro-elastic bodies, even if the surfaces of the separators have varying or stepped heights, the contact members easily make electrically contact with the corresponding separators. Accordingly, reliability of the device for measuring an electrical output is further improved.

In addition, according to some embodiments, since the terminal members of the device for measuring an electrical output are formed by micro-machining, dimensional accuracy is high, mass production is possible, and manufacturing costs are low.

While certain exemplary embodiments have been described herein, those skilled in the art will understand that various modifications, changes, and equivalent arrangements can be made within the spirit and scope of the appended claims.

What is claimed is:

1. A fuel cell stack comprising:
a body comprising an electrical generator; and
a device operable to measure an electrical output of the electrical generator electrically coupled to the electrical generator,
wherein the device comprises:
a base substrate secured to the body; and
a terminal member disposed on the base substrate and electrically coupled to the electrical generator.

2. The stack of claim 1, wherein the terminal member comprises a contact portion that is elastically deformed at a contact point with the electrical generator.

3. The stack of claim 2, comprising a space between the contact portion and the base substrate.

4. The stack of claim 1, wherein the terminal member comprises a micro-elastic body.

5. The stack of claim 1, wherein the terminal member comprises:
a first portion comprising an elastic body; and
second portions coupled to the first portion and fixed to the base substrate, thereby supporting the first portion.

6. The stack of claim 5, wherein the first portion comprises a plate spring that projects from the second portions.

7. The stack of claim 6, wherein a cross-section of the first portion has a trapezoidal shape.

8. The stack of claim 5, wherein a second portion is disposed at each end of the first portion, and one of the second portions comprises a lead electrically coupled to a connector.

9. The stack of claim 1, wherein the terminal member comprises a nickel-based metal plated on a conductive metal thin film.

10. The stack of claim 1, further comprising a contact member on the terminal member, wherein the contact member is electrically coupled to the electrical generator.

11. The stack of claim 10, wherein the contact member is adhered to the terminal member.

12. The stack of claim 11, wherein the contact member has a ball shape.

13. The stack of claim 10, wherein the contact member comprises a projection on the terminal member.

14. The stack of claim 1, wherein the terminal member is electrically coupled to a circuit pattern disposed on the base substrate.

15. The stack of claim 14, wherein the terminal member is electrically coupled to a detector through a connector disposed on the base substrate.

16. The stack of claim 15, wherein the detector comprises at least one of a voltmeter and an ammeter.

17. The stack of claim 3, further comprising engaging members securing the base substrate to the body.

18. The stack of claim 1, wherein
the body comprises a plurality of electrical generators and the device comprises a plurality of terminal members, and
each terminal member is coupled to a corresponding electrical generator.

19. The stack of claim 18, wherein
the body comprises pressing plates disposed at outermost sides, and
engaging members secure the base substrate to the pressing plates.

20. The stack of claim 3, wherein the body comprises a small sized cell comprising a conductive separator with a thickness of from about 1 mm to about 1.2 mm.

21. A fuel cell stack comprising:
a body comprising a plurality of electrical generators; and
a device secured to the body operable to measure an electrical output from each electrical generator.

22. The stack of claim 21, wherein the device is disposed on a side face of the body.

23. A device for measuring an electrical output from a plurality of electrical generators of a fuel cell stack, the device comprising:
a base substrate dimensioned and configured for securing to a body of a fuel cell stack; and
a plurality of terminal members disposed on the base substrate, wherein each terminal member is operable for electrical coupling to a corresponding electrical generator of a fuel cell stack,
wherein each terminal member comprises a micro-elastic body.

24. The device of claim 23, wherein a terminal member comprises a contact portion dimensioned and configured to be elastically deformed at a contact point with the electrical generator to form a space between the contact portion and the base substrate.

25. The device of claim 23, wherein
a terminal member comprises a first portion comprising an elastic body and second portions connected to the first portion and fixed to the base substrate, thereby supporting the first portion, and
the first portion comprises a plate spring projecting from the second portions.

26. The device of claim 23, further comprising a contact member disposed on the terminal member, dimensioned and configured for electrical coupling to the electrical generator.

27. The device of claim 26, wherein the contact member is ball shaped and is adhered to the terminal member.

28. The device of claim 26, wherein the contact member comprises a projection on the terminal member.

29. The device of claim 23, wherein the terminal member comprises a nickel-based metal plated on a conductive metal thin film.
